(19) United States
(12) Patent Application Publication
(10) Pub. No.: US 2012/0040325 A1
(43) Pub. Date: Feb. 16, 2012

(54) METHOD AND SYSTEM FOR ONLINE LEARNING WITH CUSTOMIZED ANSWER EXPLANATIONS BASED ON STUDENT RESPONSES

(75) Inventor: Robert Gange, San Francisco, CA (US)

(73) Assignee: Perfect800, Inc., San Francisco, CA (US)

(21) Appl. No.: 13/207,320

(22) Filed: Aug. 10, 2011

Related U.S. Application Data
(60) Provisional application No. 61/372,409, filed on Aug. 10, 2010.

(51) Int. Cl. G09B 3/00

(52) U.S. Cl. 434/350

(57) ABSTRACT

The online learning system provides customized answer explanations based upon a user's incorrect response to a multiple choice question. The explanations identify trick answers and how to avoid them, incorrect assumptions, and/or incorrect calculations that caused the student to reach the incorrect solution. The system also tracks the user's progress and provides customized feedback based on measurable aspects of the user's progress. Course material is provided by the system using a video game and/or social gaming type of user interface that fosters competition to motivate students and also uses incentives such as experience points, levels of mastery, and the ability to earn virtual goods or unlock challenges as the user progresses.

### CROSS-REFERENCE TO RELATED APPLICATIONS

This application claims the benefit of U.S. Provisional Application No. 61/372,409 entitled “METHOD AND SYSTEM FOR ONLINE LEARNING WITH CUSTOMIZED ANSWER EXPLANATIONS BASED ON STUDENT RESPONSES”, filed Aug. 10, 2010, and is hereby incorporated by reference in its entirety.

### TECHNICAL FIELD

The present invention relates to online education/online test preparation, and more specifically to returning question/answer explanations that are particular to what response the student chose. The separate explanation specifically identifies for the student their mistake in choosing an incorrect answer choice, as well as providing the methodology behind the correct answer.

The invention further relates to the use of social gaming within the context of eLearning. This invention includes but is not limited to the ability to challenge other users to “quiz battles”, where students can challenge each other to take the same quiz and results are given afterwards; the video game-like interface where a user is constantly accumulating “experience points”, increasing their level/status, and unlocking new “mini challenges” as they progress through our application.

### BACKGROUND

Outside of the classroom, when students are studying on their own without an instructor, written answers to problems that a student is working on may be available, but it may be difficult for the student to understand a general explanation. Further, students often find studying on their own to be boring and are unmotivated.

### SUMMARY

The present invention contemplates a variety of improved methods and systems for online studying. Rather than return a “one-size-fits-all” answer explanation for online questions and quizzes, we return individualized answers that take into account the answer choices the student submitted, just as a real teacher would. We constantly monitor the users' progress and answer selections, then guide the student accordingly based on these results. If a student selects an incorrect response that can be calculated using incorrect assumptions or a false methodology, we identify the specific mistake the student used as to prevent this issue from happening again in the future. Essentially, most of the time there aren't really “trick questions” on exams, but it is very likely that there will be “trick answers.” This is especially true on multiple choice exams, where the creator of the exam needs certain answer choices to be appealing based on some false methodology, that way a student who has some familiarity with the material (but not enough) might be tricked into selecting that “trick answer.” Most of the time however, there is a simple, and short explanation for why this answer selection is incorrect. Explaining to the student why their answer choice is wrong is often more important than explaining the correct methodology for doing the question correctly.

There is a finite number of tricks that an exam creator can use to create trick answers, and by explaining the logic behind the trick answers, we are equipping our students with the tools to identify these tricks on the real exam. This is applicable across all subject matters, not just mathematics.

For social gaming, our invention is to encompass the fun, competitive, motivational aspects of a social video game, and incorporate them into online education. Many students are driven by accomplishments within a game-like interface and the system and method introduced here motivate students to study based on this fact. Also, lots of students are motivated by competition with their friends, so we have incorporated a way for students to compete with each other and view the results of that competition. To promote this competition, a leaderboard is displayed which demonstrates relative proficiency at our challenges/games. The results of such said competitions can also be incorporated with and displayed on relevant social networks, such as facebook.

### BRIEF DESCRIPTION OF DRAWINGS

Examples of a system generating pre-engineered questions and detailed explanations for the answers are illustrated in the figures. The examples and figures are illustrative rather than limiting.

FIG. 1 shows an example of a pre-engineered question and an example answer designed to explain to the student why he may have selected a wrong answer choice.

FIG. 2 shows an example progress indicator for a student based upon the student's answers.

FIG. 3 shows an example of a pre-engineered question and an example explanation that accompanies a student's selection of an incorrect answer choice.

FIG. 4 shows a block diagram of an example system that provides pre-engineered questions and explanations for incorrect answer choices.

FIG. 5 shows a flow chart illustrating an example of a method of providing pre-engineered questions and answer explanations.

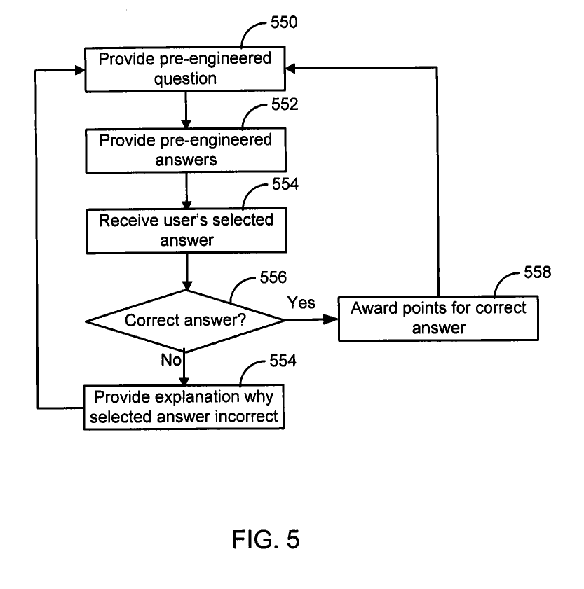

### DETAILED DESCRIPTION

Various aspects and examples of the invention will now be described. The following description provides specific details for a thorough understanding and enabling description of these examples. One skilled in the art will understand, however, that the invention may be practiced without many of these details. Additionally, some well-known structures or functions may not be shown or described in detail, so as to avoid unnecessarily obscuring the relevant description.

The terminology used in the description presented below is intended to be interpreted in its broadest reasonable manner, even though it is being used in conjunction with a detailed description of certain specific examples of the technology. Certain terms may even be emphasized below; however, any terminology intended to be interpreted in any restricted manner will be overtly and specifically defined as such in this Detailed Description section.

The techniques described herein attempt to alleviate two problems. First, the feeling a student has when they are learning without an instructor, and they understand the explanation, but don't know where they went wrong. We alleviate this problem by explaining to the student not only how to do the problem correctly, but we try to correct bad habits by identifying calculation/fundamental mistakes for the student as well. We sometimes then provide tips on how to avoid this mistake in the future.

Next, sudying is boring. We have introduced a social gaming aspect to online learning so that students have that extra motivation to put in the time to study. This aspect can be competitive for students who prefer to compete with their friends, or they can work through the game themselves, but we are relying on the mass-appeal of video and social games to further motivate students to study.

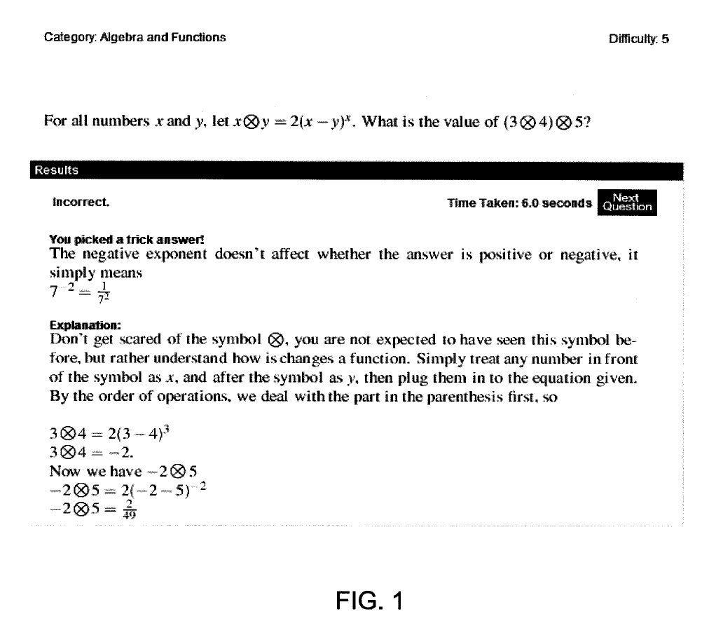

In FIG. 1 we illustrate how we have pre-engineered the question to output an answer that is specific to the student's response. Here a student picked a “trick answer”, where their calculations got them an incorrect result. We have described for the student not only how to do the problem correctly, but also where their thought process was incorrect/where they went wrong. We have done this by engineering our questions to have separate explanations, depending on what the student picked on each particular problem. This allows for a more personalized experience than simply giving one answer for every response.

Also please note that the question is segmented by category and difficulty level (there are more detailed question tags beneath the surface—question DNA if you will), and we have kept track of time spent. This enables us to give more “macro-level” feedback on student trends as they progress throughout our program.

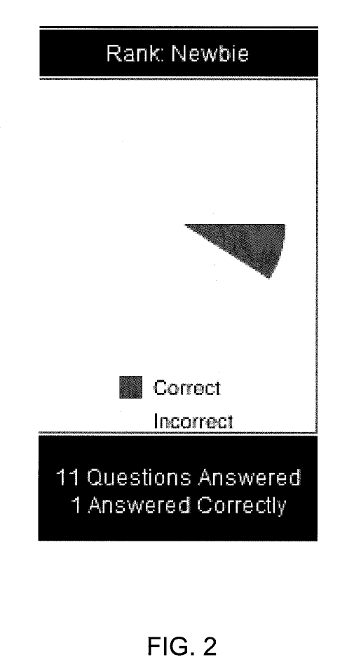

FIG. 2 shows the progress of a user on our site, who has attained the rank of Newbie. Other status indicators such as experience points, virtual goods that the user has earned, and different progress statistics/rewards can also be displayed. There will also be a quick leaderboard amongst each user and a predefined group of users (friends, classmates, or everyone using our site).

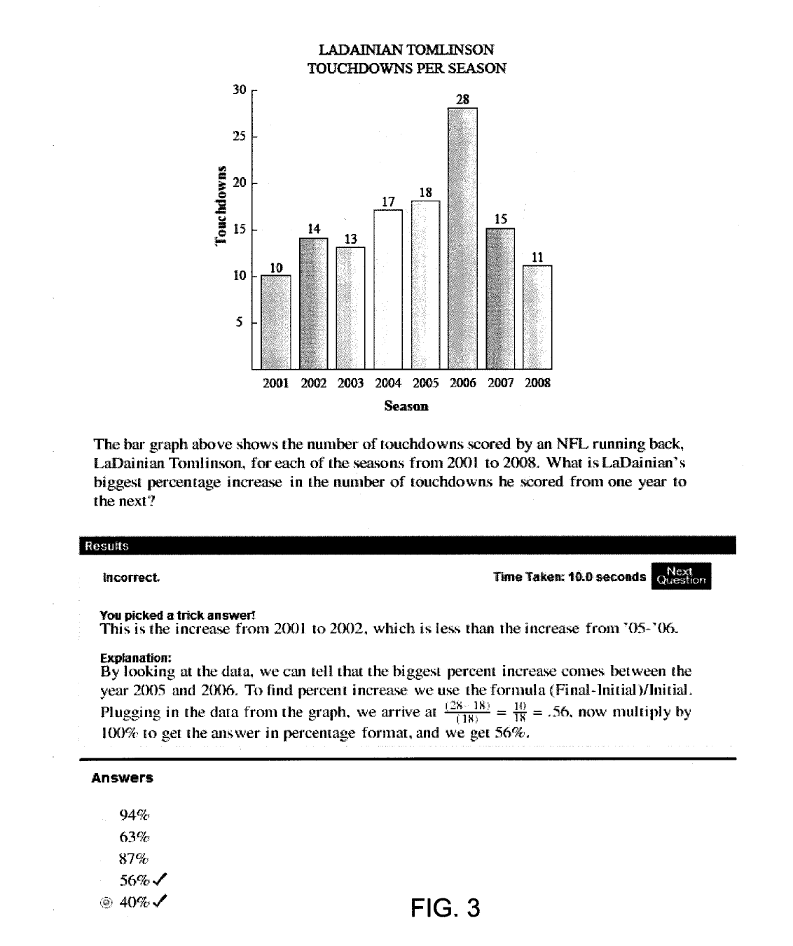

FIG. 3 is another example of an additional explanation being given when the user selects the incorrect answer choice. Here the student has selected 40%, when the correct answer is 56%. See FIG. 1 explanation for more clarity (if necessary).

The learning software as described herein varies answer explanations based on the response that the student selects. This includes answers to individual questions guide students on the “micro-level” in isolation, and on the “macro-level” where we have aggregated data and specifics about each student.

“Micro level” guidance includes instructions that guide the student away from bad habits that we have identified based on their selection of a “trick answer”, or an answer which is chosen based on a false calculation or using false logic. We explain to the student where they made their mistake, so they are able to quickly move on to the correct explanation, rather than spend minutes attempting to figure out their mistake. This is applicable across all subjects, all exam types and all levels of learning.

The above examples of “micro level” guidance include math related questions. However, students can also be provided with “micro level” instruction in other subjects. For example, suppose a student answers for a history question that the first president of the USA was John Adams rather than George Washington (the correct answer). We would consider this a “trick answer” for a couple of reasons: 1) that John Adams was the first vice president of the USA and 2) that John Adams was the second president of the USA. We would let the student know these related facts, so they can immediately understand where their line of thinking or assumptions they made were false.

“Macro level” guidance refers to our tracking of student progress throughout the application as a whole, and our individualized comments and learning suggestions based on this progress. The basis for this analysis is the detailed way in which we have “tagged” our own content, so that we can differentiate success/failure in certain areas from others. We also keep track of the time spent on each question for further analysis and feedback. For example, if a student is taking too little time on their geometry questions, and say we have data that a student does significantly better when they spend more than 30 seconds on these types of questions, we will give this individualized feedback. You can see in our screenshots that we keep track of time spent on each question, and this information will become part of our analytical analysis.

The online learning method introduced here can have a structure similar to many video games and social games in the fact that students accumulate experience points as they progress throughout the curriculum, level up as they gain expertise and answer quizzes/questions correctly, and complete challenges which are unlocked in synchronization with their progress. This structure is an attempt to emulate the success of video games to keep the attention and focus of its users and to redirect this focus/attention towards learning. Rather than kill bad guys to advance to the next level, unlock the next challenge/feature/functionality/helpful tip, the user must exhibit sufficient proficiency in the material attempting to be taught on our interface (which is tracked through experience points, and competency on questions/quizzes). The social aspect is further meant to motivate students as users will see their peers advancing to higher ranks, accumulating virtual goods/rewards for their progress, and unlocking new features/challenges/tips that they do not have access to. Furthermore, the users can actually challenge each other to academic battles, where they complete the same set of questions in a timed format. Students will be judged on a mix of questions answered correctly and time taken. All of these parameters are configurable based on the specific goals/needs of the course material and the instructor.

Furthermore, we have each type of question tagged according to subject matter and difficulty for future analytical purposes. When we identify trends for each student, we are able to give them feedback specific to the types of problems they are having success/failure with. We also keep track of time spent, so our analysis can include references to this metric as well.

Students are often more motivated to beat their friends than to beat their previous score, and this competitive aspect can drive students to new heights in terms of their potential. The ability to challenge other students to measures of proficiency/competency therefore is core to our invention which blends competition into studying, which is typically done alone or in a collaborative fashion. While we still embrace the merit in both of these methods of studying, we feel that competition breeds the best results, and therefore have integrated ways for students to be competitive with each other into our main application. This goes from a direct challenge standpoint, all the way into comparing levels/progress/virtual goods accumulated, and content answered correctly. Different measures of all of this information can be made public to different levels of users. For instance, some of it may only be visible to the individual user, some visible to the user and their “friends” or schoolmates (within the same class/high school/geographic area), some visible to a group of students and their proctor/teacher/tutor, some visible to the entire user base, and some visible to the public. These settings can differ based on the course content/background and preferences of the proctor/student/course.

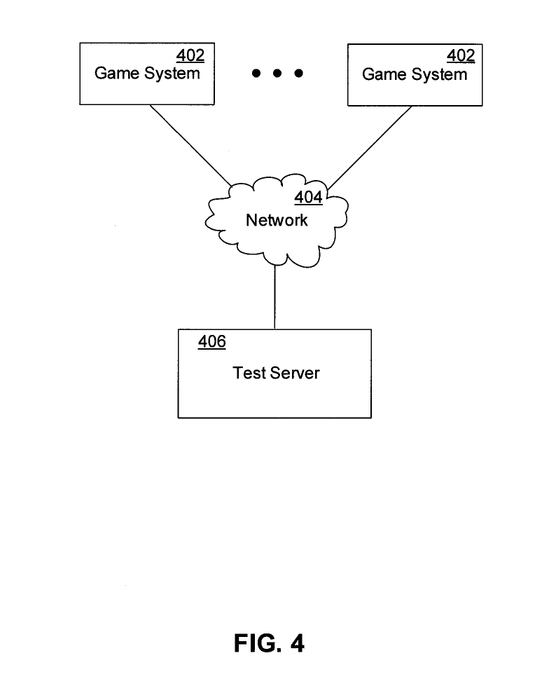

FIG. 4 is an example block diagram of a system employing the techniques introduced here. The system includes at least one client computer system 402 attached to a network 404. A test server 406 is also connected to the network 404. Communication between the various client systems and the test server takes place over the network 404. The network can be a packet-switched network, for example, a local area network (LAN) or wide area network (WAN), a public network (e.g., the Internet) a virtual private network implemented over a public network, or any other network configuration suitable for transmitting data between the components of the system. When a student initially begins a practice session on the client system 402, the client system connects to the test server 406 to provide questions that are presented to the student. The student then can select an answer and receive explanations based on the answer selected. The answers and explanations are transferred from the test server 406 to the client system 402 over the network 404.

When the player has reached an achievement, the client system 402 can post a notification of the achievement to a server hosting the student's social networks (not shown).

While the example of FIG. 4 shows a network based system with client systems and a test server, the system can be implemented on a single client system with the questions and answers being received from a local machine readable medium, for example on a CD-ROM, DVD, or other non-volatile memory.

The techniques introduced above can be implemented by programmable circuitry programmed or configured by software and/or firmware, or they can be implemented by entirely by special-purpose “hardwired” circuitry, or in a combination of such forms. Such special-purpose circuitry (if any) can be in the form of, for example, one or more application-specific integrated circuits (ASICs), programmable logic devices (PLDs), field-programmable gate arrays (FPGAs), etc.

Software or firmware for implementing the techniques introduced here may be stored on a machine-readable storage medium and may be executed by one or more general-purpose or special-purpose programmable microprocessors. A “machine-readable medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible medium includes recordable/non-recordable media (e.g., read-only memory (ROM); random access memory (RAM); magnetic disk storage media; optical storage media; flash memory devices; etc.), etc.

The term “logic”, as used herein, can include, for example, special-purpose hardwired circuitry, software and/or firmware in conjunction with programmable circuitry, or a combination thereof.

In addition to the above mentioned examples, various other modifications and alterations of the disclosure may be made without departing from the invention. Accordingly, the above disclosure is not to be considered as limiting and the appended claims are to be interpreted as encompassing the true spirit and the entire scope of the invention.

### CONCLUSION

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or subcombinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶ 6 will begin with the words “means for.”) Accordingly, the applicant reserves the right to add additional claims after filing the application to pursue such additional claim forms for other aspects of the invention.

We claim:

1. A method of providing a user an online learning application, the method comprising:
providing a plurality of pre-engineered questions along with a plurality of pre-engineered answer choices for each question, wherein the pre-engineered questions are based upon educational material, and the pre-engineered answers are based upon mistakes made by students in answering the pre-engineered questions;
upon receiving an answer selection for a pre-engineered question that is wrong, providing an explanation for why the answer selection is wrong, wherein the explanation includes false calculations, false logic, or false assumptions that can lead to selecting the wrong answer, and further wherein the customized explanation is different for each of the plurality of answer choices that is wrong.

2. The method of claim 1, further comprising:
tagging each of the plurality of pre-engineered questions according to subject matter and difficulty;
tracking the user's answer selections;
analyzing the user's answer selections for each of the tagged questions to provide individualized comments and learning suggestions based on the user's progress.

3. The method of claim 2, wherein tracking includes monitoring time spent by the user on each question before selecting an answer.

4. The method of claim 1, further comprising:
upon receiving an answer selection for a pre-engineered question that is correct, awarding progress points to the user.

5. The method of claim 4, wherein the progress points can be exchanged by the user for virtual goods or other rewards.

6. The method of claim 4, wherein the progress points can be used by the user to unlock new features or challenges provided by the online learning application.

7. The method of claim 1, further comprising tracking progress points for a plurality of users, and providing an online leaderboard of users who have accumulated the highest number progress points, wherein the online leaderboard is available to all user.
